(19) United States
(12) Patent Application Publication
(10) Pub. No.: US 2013/0128131 A1
(43) Pub. Date: May 23, 2013

(54) LUMINESCENT SOLAR CONCENTRATOR AND METHOD FOR MAKING THE SAME,

(71) Applicants: Timothy Schmidt, Forest Lodge (AU); Rowan Macqueen, Orange (AU)

(72) Inventors: Timothy Schmidt, Forest Lodge (AU); Rowan Macqueen, Orange (AU)

(73) Assignee: THE UNIVERSITY OF SYDNEY, Sydney, New South Wales (AU)

(21) Appl. No.: 13/640,779

(22) PCT Filed: Apr. 13, 2011
(86) PCT No.: PCT/AU11/00424

§ 371 Date: Jan. 24, 2013

(30) Foreign Application Priority Data
Apr. 13, 2010 (AU) 2010901566

(51) Int. Cl. F21V 8/00; B05D 5/06

(52) U.S. Cl. CPC G02B 6/0003; B05D 5/06
USPC 349/1; 385/141; 252/301.17; 427/162; 156/60

(57) ABSTRACT

A luminescent solar concentrator (10) is disclosed. The luminescent solar concentrator (10) has a light guide (12) defined at least in part by a reflector (14). It has a plurality of light absorbing centers (24) located in the light guide. The light absorbing centers (24) are configured to absorb sunlight (25) instant on the light guide (12). There are a plurality of light emitting centers (26) located in the light guide (14). Each of the plurality of light emitting centers (26) are capable of emitting light (18) after at least some of the energy of the absorbed sunlight (25) is transferred (28) from a respective one of the light absorbing centers (24). Each of the plurality of light emitting centers (26) are orientated relative to the reflector (14) to enhance the proportion of light emitted by the respective light emitting center (26) that is reflected by the reflector (14) and so guided within the light guide (12).

### FIELD OF THE INVENTION

The present invention generally relates to a light guide having light absorption and emission properties, wherein the angular dependence of the light emission enhances the proportion of the emitted light that is guided within the light guide, and particularly but not exclusively to a luminescent solar concentrator having the light guide.

### BACKGROUND OF THE INVENTION

In a prior art luminescent solar concentrator (LSC), an ensemble of luminophores within a light guide absorb incident sunlight. The sunlight-excited luminophores then emit light approximately isotropically. Some of the light is captured by the light guide, which guides and concentrates the light to, for example, a photovoltaic (PV) cell for the generation of electricity.

Approximately one quarter of the light generated within a prior arc LSC, however, does not hit a waveguide surface at an angle to satisfy total internal reflection and is lost.

### SUMMARY OF INVENTION

According to a first aspect of the invention, there is provided a luminescent solar concentrator (LSC) comprising:

a light guide defined at least in part by a reflector;

the light guide having a plurality of light absorbing centers that absorb sunlight incident on the light guide;

the light guide also having a plurality of light emitting centers;

each of the plurality of light emitting centers being capable of emitting light after at least some of the energy of the absorbed sunlight is transferred to it from one or more of the light absorbing centers;

each of the plurality of light emitting centers being orientated relative to the reflector to enhance the proportion of light emitted that is guided within the light guide.

In an embodiment, the reflector is located adjacent an interface. The reflector may be the interface. The interface may be that of two materials having different refractive indices. The reflector may operate by total internal reflection. At least some of the plurality of light absorbing and emitting centers may be located in the light guide. At least some of the plurality of light absorbing and emitting centers may be located adjacent a surface of the light guide.

Each of the absorbing centers may have at least one of: D₄ₕ symmetry; a symmetry higher than D₄ₕ; and spherical symmetry.

Each of the plurality of light emitting centers may have an axis substantially orthogonal to the reflector. The axis may be a symmetry axis. The axis may be defined by a transition dipole moment of the axis. The light emitting center may be elongated along the axis. The centers may be arranged such that the light emitted by each of the centers may be greatest in a direction substantially orthogonal to the axis. The light emitted by each of the centers may be least in a direction parallel to the axis.

The energy transfer may be via at least one of Förster resonance energy transfer (FRET), ISC, TET, DEXTER, near field communication, IC and rISC.

The light emitting centers may comprise a molecule. The molecule may be linear. The molecule may be rigid. The molecule may be perylene or derived from perylene, for example N-N′-Bis(2,6-dimethylphenyl)perylene-3,4-9,10-tetracarboxylic diimide. The molecule may be a rylene, such as a terrylene or a quaterrylene.

Each of the light absorbing centers may comprise a molecule. The molecule may be one of: a porphyrin molecule; a pthalocyanine molecule; and a polycyclic aromatic hydrocarbon molecule.

The light guide may comprise a center hosting substance in which the centers are hosted. The light emitting centers may be orientated by the center hosting substance. The light absorbing centers may be orientated by the center hosting substance. The center hosting substance may comprise liquid crystal -molecules. The liquid crystal may comprise 4-Pentylphenyl 4-methoxybenzoate.

The LSC may comprise two pieces between which the center hosting substance is located. The pieces may be of a transparent material such as a glass. The pieces may be electrically conductive. At least one of the pieces may have a conducting layer.

In an embodiment, the center hosting substance, for example the liquid crystal, is orientated by the application of an electric field. Alternatively, the center hosting substance, for example the liquid crystal, is orientated by the influence of an alignment-inducing species. The alignment-inducing species may, for example, comprise a surfactant molecule such as DMOAP (dimethyloctadecyl[3-(trimethoxysilyl) propyl] ammonium chloride) or HMAB (hexadecyltrimethylammonium bromide). The alignment-inducing species may be bound to the pieces. The orientation of the alignment-inducing species causes a corresponding orientation of the liquid crystal molecules (or constituents of another hosting substance). This in turn orientates the light absorbing centers. The orientation of the liquid crystal (or constituents of the other hosting substance) may orientate the light emitting centers.

In an embodiment, each center is a light absorbing and/or light emitting center.

In an embodiment, each light absorbing center is located in very close proximity to a light emitting center. Each light emitting center may form a supra-molecule with a respective one of the light absorbing centers. In this case, the absorbing centers may not require a particular symmetry.

In a second aspect of the invention, there is provided a light guide having light absorption and emission properties, wherein the angular dependence of the light emission enhances the proportion of the emitted light that is guided within the light guide.

In an embodiment, the angular dependence of the light absorption may be different than the angular dependence of the light emission. The angular dependence of the light absorption may enhance the proportion of a light incident on the light guide that is absorbed. The light guide may comprise a plurality of light emitting centers that emit light after being energized. The light guide may comprise a plurality of light absorbing centers that each absorb light incident on the light guide and transfer at least some of the energy of the absorbed light to one of the light emitting centers and so energise it. Each of the absorbing centers may have two dipoles that are orthogonal and are degenerate in energy. The dipoles may be electronic transition dipoles. The absorbing centers may each have at least one of: D₄ₕ symmetry; symmetry higher than D₄ₕ; cubic symmetry, and spherical symmetry. The emitting centers may have a long axis and emit light from only one optical transition dipole located on the long axis. The transfer of at least some energy may happen with high efficiency. The transfer of the at least some energy may be via one of Förster resonance energy transfer (FRET), ISC, TET, DEXTER, IC, and rISC.

Each of the light emitting centers may comprise at least one of a molecule, and a quantum structure. The molecule may be linear. The molecule may be substantially rigid. The molecule may be perylene or derived from perylene, for example N-N′-Bis(2,6-dimethylphenyl)perylene-3,4-9,10-tetracarboxylic diimide. The molecule may be a rylene, such as a terrylene or a quaterrylene.

Each of the light absorbing centers may comprise at least one of a molecule, and a quantum structure such as a quantum dot or a quantum wire. The molecule may be one of: a porphyrin molecule; a pthalocyanine molecule; and a polycyclic aromatic hydrocarbon molecule.

The light guide may comprise a center hosting substance in which the centers are hosted. The light emitting centers may be orientated by the centre hosting substance. The center hosting substance may comprise liquid crystal molecules. The liquid crystal may comprise 4′-Pentylphenyl 4-methoxybenzoate (also known as 4-n-Pentylphenyl p-anisate, 4-Amylphenyl 4?-methoxybenzoate, Nematal 105 or CAS Number 38444-13-2).

The light guide may comprise two pieces of material between which the hosting material is located. The pieces may be of a transparent material such as a glass. The pieces may be electrically conductive. At least one of the slabs may have a conducting layer.

The light guide may comprise a surface adapted to pass a light incident on the surface, and each light emitting center has an axis that is substantially orthogonal to the surface. The light emitted by each of the centers may be greatest in a direction substantially orthogonal to the axis.

In an embodiment, the center hosting substance, for example the liquid crystal, is orientated by the application of an electric field. Alternatively, the center hosting substance, for example the liquid crystal, is orientated by the influence of an alignment-inducing species. The alignment-inducing species may, for example, comprise a surfactant molecule- such as DMOAP (dimethyloctadecyl[3-(trimethoxysilyl) propyl] ammonium chloride) or HMAB (hexadecyltrimethylammonium bromide). The alignment-inducing species may be bound to the pieces. The orientation of the alignment-inducing species causes a corresponding orientation of the liquid crystal molecules (or constituents of another hosting substance). This in turn orientates the light absorbing centers. The orientation of the liquid crystal (or constituents of the other hosting substance) may orientate the light emitting centers.

According to a third aspect of the invention there is provided a luminescent solar concentrator comprising a light guide defined by the second aspect of the invention.

According to a fourth aspect of the invention, there is provided a material having light absorption and emission properties, the angular dependence of the light absorption being different than the angular dependence of the light emission.

According to a fifth aspect of the invention there is provided a method of fabricating a light guide, the method comprising the steps of:

forming a layer having a plurality of light emitting centers aligned with respect to each other; and

forming a layer having a plurality of light absorbing centers;

wherein the layers are configured to transfer energy from at least one of the light absorbing centers to at least one of the light emitting centers.

In an embodiment, the step of forming one of the layers may use a self assembly process. One of the layers may be on top of the other.

In an embodiment, the method may further comprise the steps of:

providing a surface;

and coating the surface with a coating

to which either the light emitting centers or light absorbing centers can bond.

In an embodiment, the method comprises the step of modifying either the light emitting centers or the light absorbing centers to have end groups that can bond to the coating. The method may comprise the step of bonding the modified light emitting centers to the coating. The method may comprise the step of forming a capping layer. The step of forming one of the layers may comprise applying a liquid.

### BRIEF DESCRIPTION OF THE FIGURES

In order to achieve a better understanding of the nature of the present invention, embodiments will now be described, by way of example only, with reference to the accompanying figures in which:

FIG. 1 shows a cross sectional view of a LSC according to an embodiment of one aspect of the invention;

FIG. 2 shows an emission distribution of a light emitting center within the LSC of FIG. 1;

FIG. 3 shows representations of various symmetries that absorbing centers may have in an embodiment;

FIG. 4 shows a perspective view of another embodiment of a LSC according to one aspect of the invention;

FIGS. 5 and 6 show the orientation of light emitting centers in the embodiment of a LSC shown in FIG. 3 without and with an applied voltage respectively;

FIG. 7 shows an example of emitting and absorbing centers arranged in layers on a substrate;

FIG. 8 shows various possible configurations of supra-molecules containing absorbing and emitting centers;

FIG. 9 shows a flow diagram of an embodiment of a method of fabricating a light guide; and

FIG. 10 shows a schematic diagram of a portion of another embodiment of a LSC.

### DETAILED DESCRIPTION OF EMBODIMENTS OF THE INVENTION

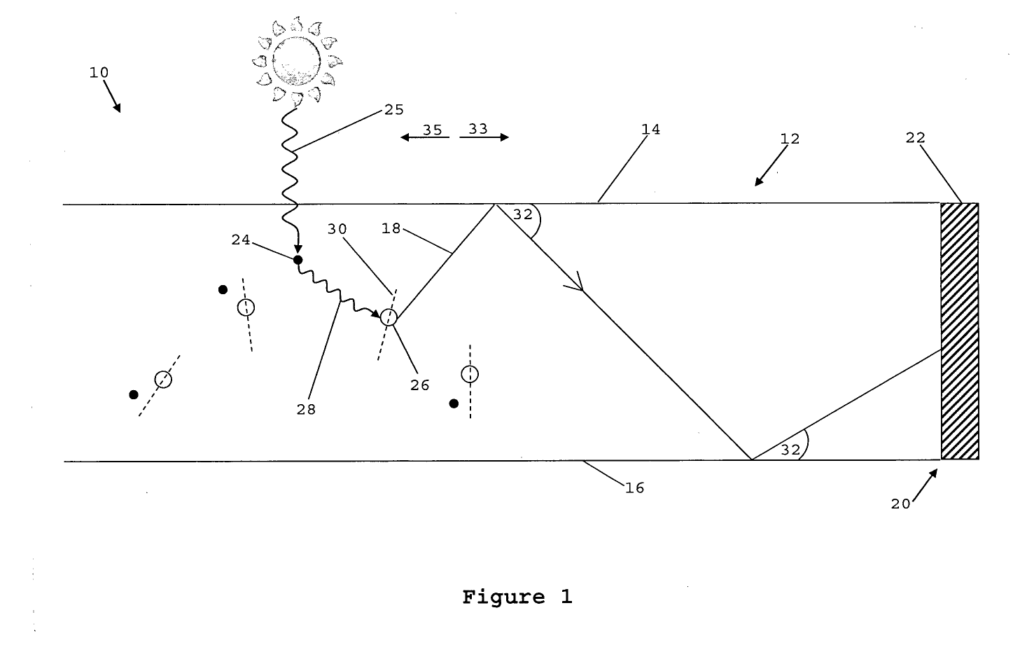

FIG. 1 is a cross sectional view of an embodiment of a luminescent solar concentrator (LSC) generally indicated by the numeral 10. The LSC comprises a light guide 12, in this embodiment in the form of a slab of Poly(methyl methacrylate) or PMMA for short. In this embodiment, but not necessarily all embodiments, the slab is surrounded by a gas, specifically air, which has a significantly lower refraction index (nₐᵢᵣ˜1.0) than the PMMA (N_{PMMA}˜1.4). Alternatively, the slab may be clad with a material of relatively low refractive index. The top 14 and bottom 16 surfaces of the slab 12 reflect, by way of total internal reflection at the PMMA/air interface, a ray of light such as that indicated by the numeral 18 back into the guide 12. Thus, the top 14 and bottom 16 surfaces each act as a reflector. Some rays such as that indicated by the numeral 18 will thus be guided towards an end 20 of the guide 12 at which a photovoltaic cell 22 is located. The ray of light 18 is absorbed by the photovoltaic cell generating power.

There is a plurality of light absorbing centers, such as 24, located in the light guide 12, generally shown in FIG. 1 as filled in circles. They absorb sunlight 25 incident on the light guide 12 which passes through the top surface 14. The top surface 14 is typically orientated to maximize exposure to the sun. There is also a plurality of light emitting centers, such as 26, generally shown as open circles, located in the light guide 12. Some of the energy of the sunlight 25 absorbed by the absorbing centers 24 is transferred to the light emitting centers 26. After the emitting center 26 is energised by the energy transfer it emits a light, such as 18. The energy transfer 28 is in this embodiment via Förster resonance energy transfer (FRET) but other energy transfer processes may be employed.

Förster resonance energy transfer is a mechanism in which energy is nonradiatively transferred between two species. A donor species, initially in its electronic excited state, transfers energy to an acceptor species, typically less than 10 nm away (this distance may be considerably smaller or larger) through non-radiative dipole-dipole coupling.

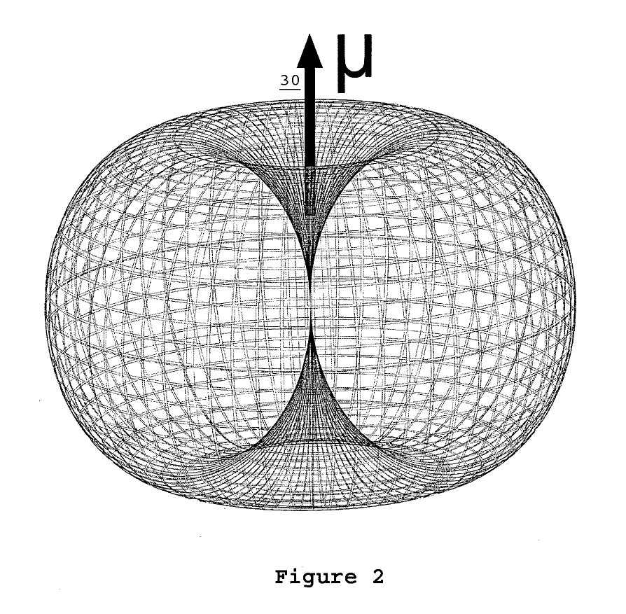

Each of the plurality of light emitting centers 26 are orientated relative to the reflecting top 14 and bottom 16 surfaces to enhance the proportion of emitted light that is reflected by the surfaces. The emitted light is guided towards the end 20 (or alternatively the opposing end, which is not shown), at which another photovoltaic cell or a mirror may be placed. The emission of light by each of the light emitting centers 26 has an angular dependence. FIG. 2 shows a light emission distribution of a light emitting center 26 around an axis 30 of the light emitting center. The axis extends in a direction in which the center is elongated, at least for this center. More generally, the center has an imaginary axis which defines a symmetry for the center. The emitting centers, at least in this embodiment, emit light from only one optical transition dipole located on the axis. The greatest amount of light emitted by each center is away from the axis 30. At least in this embodiment, most light is emitted in a direction substantially orthogonal to the axis, and the amount of light emitted in a direction parallel to the axis is minimal. By aligning the axis 30 of each center to be substantially orthogonal to the surfaces 14,16 most of the light 18 emitted by the light emitting centers 26 makes a sufficiently shallow angle 32 with the surfaces 14,16 such that the light is reflected and thus guided rather than passing across the surface 14,16 and lost. It should be understood that substantially orthogonal means that the axis makes an angle to the surface normal such that more emitted light is captured by the wave guide than if the axis of light emitters had a random orientation. In this embodiment, the axis 30 of each light emitting center is defined by a transition dipole moment of the respective light emitting center.

In this, but not necessarily in every, embodiment, the absorbing centers are also aligned. The performance of the LSC may be improved by aligning the absorbing centers. An improvement may not occur for every species of absorbing center, however. The process used to align the emitting centers may also be used to align the absorbing centers.

The absorption and emission distributions of the light emitters are, at least in this embodiment, identical and thus both may be represented by the distribution shown FIG. 2. Thus, if the light absorbers were absent and the absorption of the light emitters was solely relied on for the absorption of sunlight, the direction of minimum absorption would be the direction from which a large proportion of the sun light is coming from, which is undesirable. Consequently, using light absorbers that are different to the light emitters means that the angular dependence of the light absorption can be different than the angular dependence of the light emission and the absorption and emission processes respectively optimised.

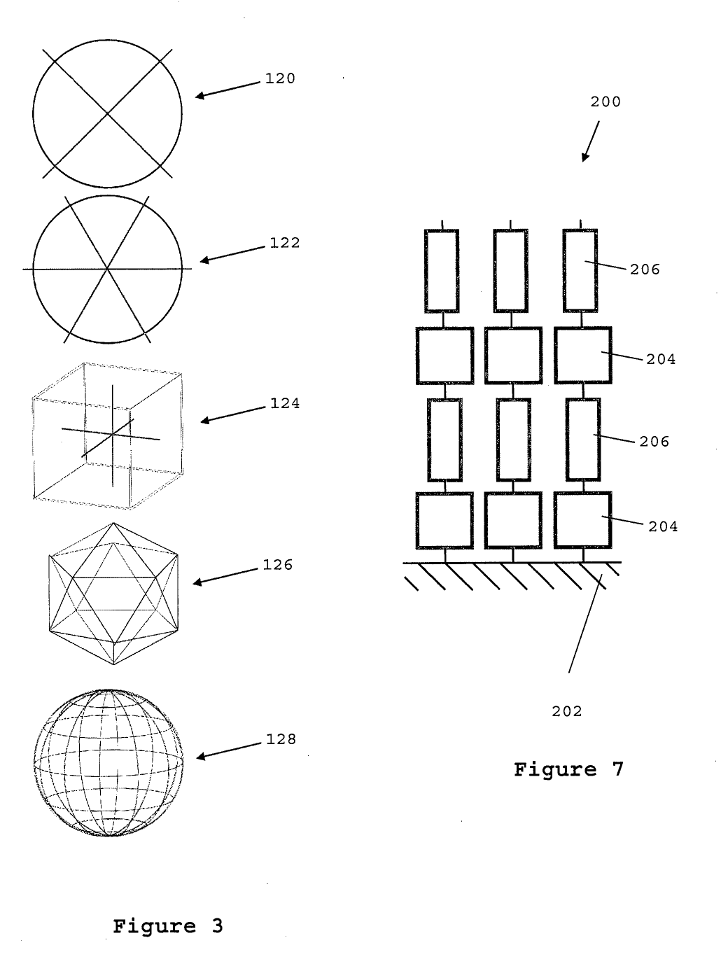

The angular dependence of the light absorption of the chosen absorption centers (otherwise referred to as chosen species) enhances the proportion of the light absorbed compared to a system containing only an emitter species. In this embodiment, the light absorbers have D₄ₕ or higher symmetry—at least to a sufficient degree that their transition dipoles could be said to possess that symmetry. Absorbers with approximately or exactly D₄ₕ symmetric have two orthogonal transition dipoles that share a common center, and have degenerate energies. One of these transition dipoles is presented skywardly as is the top surface 14 of the light guide 12 and the other transition dipole is presented in an orthogonal direction normal to the top surface 14 to maximize the rate at which energy is transferred to the aligned light emitters. Because the two transition dipoles are degenerate they rapidly exchange energy, favoring the rapid flow of energy from the sunlight, to the first transition dipole, to the second transition dipole, and then to the light emitting centers. FIG. 3 shows some symmetry groups the transition dipoles of the light absorbing species may have, such as D₄ₕ 120, D₆ₙ 122, cubic 124, icosahedral 126, and spherical 128. For light absorbing species with transition dipoles possessing any one of these symmetries, including approximately spherical symmetry, light absorption becomes more equally likely from all directions. Absorbed energy can rapidly oscillate between the various degenerate transition dipoles, again allowing the rapid transfer of energy from the excited absorber to the aligned light emitters. In some embodiments, the energy transfer happens with high efficiency. In some embodiments, the emission of light from the light emitting centers is done with a high luminescence quantum yield. That is, there is a high probability that the transfer of energy will result in the emission of light.

The light absorbing and light emitting centers may each comprise respective types of molecules, such as organic molecules, compounds or molecules containing d-block metals, or inorganic crystalline semiconductor particles. The particles may be semiconductors. Example molecules include a porphyrin molecule, a pthalocyanine molecule, a perylene molecule or a molecule derived from perylene, and a rylene such as a terrylene and a quaterrylene. In some embodiments, the organic molecules may be dye molecules. Example crystalline particles include quantum dots and nanowires. In this embodiment, each light emitting center is a linear, and rigid, molecule, specifically N-N′-Bis(2,6-dimethylphenyl) perylene-3,4-9,10-tetracarboxylic diimide, and the absorbing centers are porphyrin molecules.

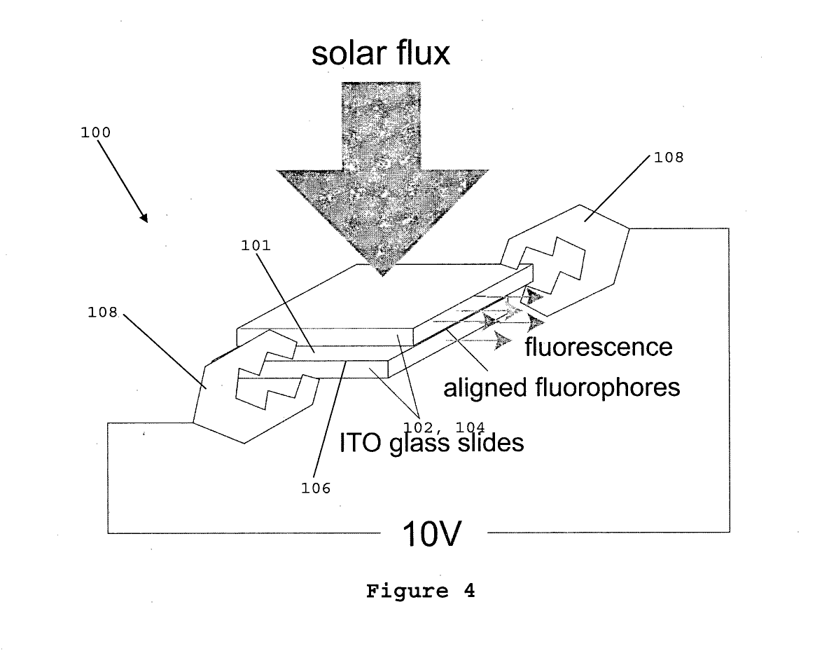

FIG. 4 shows another embodiment of a LSC generally indicated by the numeral 100. To make the LSC a small amount of a light emitter, the dye N-N′-Bis(2,6-dimethylphenyl)perylene-3,4-9,10-tetracarboxylic diimide (‘pery’ for brevity), and a light absorber was dissolved in Nematal 105 (N105) liquid crystal 101 (4-Pentylphenyl 4-methoxybenzoate) in the isotropic phase, obtained by very gentle heating in a warm water bath. The pery and N105 were sourced from Sigma-Aldrich and used without further purification. Several drops of the N105-absorber-pery solution were deposited using a transfer pipette onto a postage stamp-sized; 3 mm thick glass slide 102 (a first piece) coated on the wetted side with the transparent conducting compound indium tin oxide (ITO) 106. The slide had been cleaned by 10 minutes of sonication in analytic-grade 2-propanol. Another identical slide 104 (a second piece), similarly cleaned, was laid on top of the first with the ITO face downwards, with two parallel edges exactly aligned and a slight offset between the other two, to allow the attachment of electrical contacts to both ITO layers. Electrical clips 108 were attached to respective extension portions 110. The clips 108 were in turn connected to a voltage supply 112. The high viscosity of the N105 solution prevented significant seepage or evaporation from between the slides. Gentle pressure was applied to the top slide to evenly disperse the solution, then the slides were clamped in position across a top edge onto an optics stage.

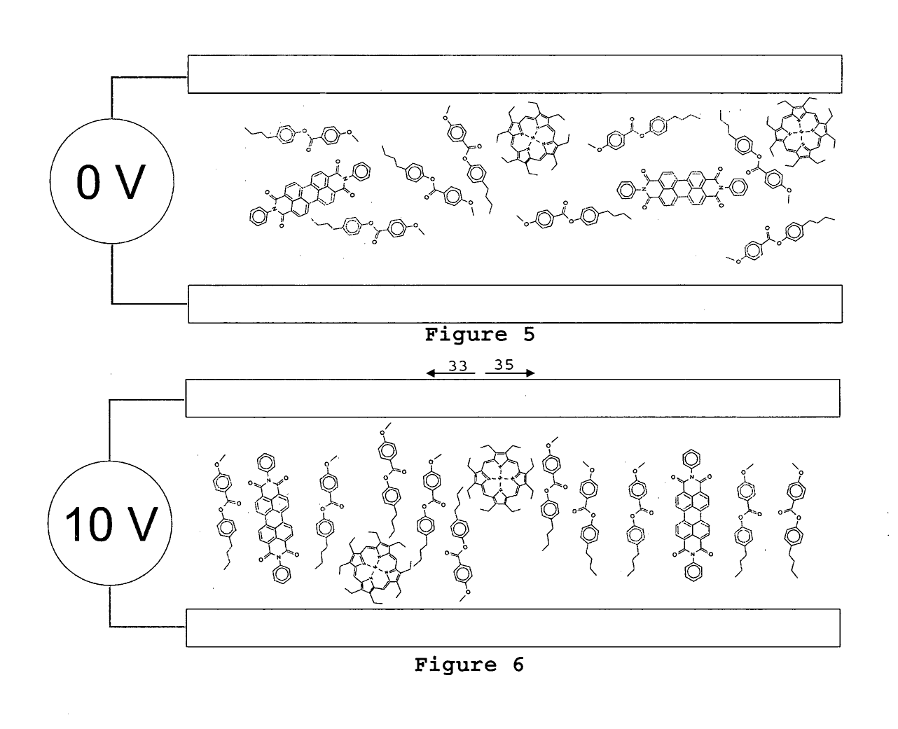

Alignment of the pery luminophores was achieved by applying a potential in the range 10 to 20V across the two ITO layers sandwiching the N105-absorber-pery solution. This was provided by a voltage supply connected to the contacts. Applying the potential caused the N105 molecules to align in the electric field, as their induced dipole moments interacted with the field and the molecules rotated to the lowest energy position, parallel with the electric field lines between the slides. The alignment of the liquid crystal solvent caused the cooperative alignment of the dissolved pery. If they were included in the liquid crystal, the absorbing centers would be similarly aligned. FIGS. 4 and 5 show the orientation of light emitting centers without and with an applied voltage respectively. The grey triangles represent the emission distribution. With the voltage applied much of the emitted light is emitted generally in the guiding directions 33,35. The absorbing center shown in FIGS. 5 and 6 is a metallated octaethyl porphyrin, intended to be representative of all possible absorbing centers.

FIG. 10 shows a schematic diagram of a portion of another embodiment of a LSC generally indicated by the numeral 400, the LSC of FIG. 10 being somewhat similar to that of FIG. 4. The orientation of the molecules of the liquid crystal, such as 402, and in turn at least some of the absorbing centers 404 and emitting centers 406 hosted by the liquid crystal, is caused by an alignment-inducing species 408 having an aligning influence on the liquid crystal molecules 402. In this embodiment, the alignment-inducing species 408 has a tether portion 412 which is tethered (e.g. by chemical bonds, such as covalent bonds or Van der Waals bonds) to a substrate 410 and an elongate portion 414 which projects substantially perpendicularly away from the substrate. In the embodiment of FIG. 10, but not in all embodiments, the substrate is a silica glass sheet.

The alignment-inducing species 408 induces bulk homeotropic alignment in some types of liquid crystal layers in the liquid crystalline phase (such as a nematic or smectic phase). Without wishing to be bound by theory, alignment of the liquid crystal molecules 402, and consequently the absorbing 404 and emitting centers 406, is believed to be achieved in this embodiment because the elongate portions 414 of the alignment-inducing species 408 influences the molecules of the liquid crystal 402 while in a liquid crystalline phase. Liquid crystal molecules 402 close to the coated substrate 410 are made to adopt certain orientations via interaction with the elongate portions 414 of the alignment-inducing species 408. The effect of this ordering is then propagated through the liquid crystal medium via interactions of the liquid crystal molecules with other liquid crystal molecules, causing homeotropic alignment of the bulk liquid crystal medium. Advantageously, an externally applied electric potential may not be required in this embodiment.

The density of the alignment-inducing species 408 on the substrate 410 required to induce bulk homeotrophic alignment will depend on the type of alignment-inducing species, liquid crystal 402, absorbing 404 and emitting centers 406. The properties of the elongate portion 414 (e.g. length, hydrophobicity, etc) required to induce bulk homeotrophic alignment will also depend on similar factors. In general, however, the number density of the alignment-inducing species 408 on the substrate 410 must be such that interaction between liquid crystal molecules 402 and the elongate portions 414 cause the liquid crystal molecules 402 to become aligned in the desired direction.

In some embodiments, the alignment-inducing species may be cross-linked. Such cross linking may increase the durability and/or rigidity of the alignment-inducing species on the substrate.

The alignment-inducing species 408 may, for example, be a surfactant molecule. Surfactant molecules typically have long (usually alkyl) linear chains and are thus capable of projecting roughly perpendicularly out from a substrate to which they are bound in order to provide a desired alignment-inducing effect. In embodiments where the substrate 410 is glass, surfactants having silyl groups are useful, because the silyl group is capable of forming strong chemical bonds with the glass substrate, thus providing a firm foundation for aligning the liquid crystal molecules.

In one embodiment the alignment-inducing species may be the surfactant dimethyloctadecyl [3-(trimethoxysilyl) propyl] ammonium chloride (DMOAP). In such an embodiment, the trimethoxysilyl group can chemically bond to a glass substrate, leaving the dimethyloctadecyl portion of the molecule to project substantially perpendicularly away from the substrate. The trimethoxysilyl group can also enable molecules of the DMOAP on the glass substance to cross-link, which may increase the durability of the coating. DMOAP, when coated on a glass surface, induces bulk homeotropic alignment in some types of liquid crystal layers in the liquid crystalline phase (such as a nematic or smectic phase). In this embodiment, the liquid crystal may be 4-cyano-4-n-pentylbiphenyl (5CB), but the liquid crystal may belong more generally to the nCB (cyanobiphenyl) or nOCB (oxycyanobiphenyl) families of liquid crystals, or any other family that exhibits suitable alignment behavior under the influence of an aligning substance.

The embodiment of FIG. 10 was prepared as follows. 70×25 mm clear glass microscope slides were cleaned by copious rinsing with methanol, followed by 3×15 minute sessions of sonication in solutions of Pyroneg detergent in Millipore distilled water. The slides were rinsed again in Millipore water then subjected to 30 seconds exposure in a nitrogen plasma cleaner. A 1:2:97 v/v DMOAP:methanol:water solution was freshly prepared, into which the cleaned slides were placed for 5 minutes, followed by copious rinsing with Millipore water and analytic-grade isopropanol. Finally, the slides were baked at 110 degrees C. for 2 hours to allow cross-linking of the DMOAP.

A mixture of 2 mM beta-octaethyl porphyrin (OEP, which are light absorbing centres having D₄ₕ symmetry) and 60 mM rhodamine 800 (R800) (the light emitting centres) was prepared in 5CB. 38 micrometer glass spacer spheres were dispersed across one face of a DMOAP coated slide, another identically coated slide was laid directly on top, and the two were held together by a rubber-tipped clip. The clip contacted the slides well outside of the area probed during experiments. A 50 microlitre drop of the 5CB-OEP-R800 mixture was placed in the middle of a clean petri dish, then the dish, the drop and the glass sandwich were warmed with a heat gun. One of the narrow edges of the slide pair was stood in the heated liquid drop, and the 5CB mixture was drawn inside by capillary action, filling approximately half of the narrow cavity between the slides.

Alignment-inducing species other than surfactants may be employed to cause homeotropic alignment of the liquid crystal. For example, the alignment inducing species may comprise a collection of discrete particles, or may take the form of a polymer. The alignment inducing species may also be polymerized after being applied to the surface.

An example of an alternative alignment-inducing species is Hexadecyltrimethylammonium bromide (also known as HMAB, or by CAB number 57-09-0), related species, and species derived from HMAB and/or its related species. Other alignment-inducing species that may be appropriate in some circumstances include lecithin, related species, and species derived from lecithin and/or its related species. Generally, any suitable alignment-inducing species may be used.

Chemical self-assembly may be used to construct another embodiment of a LSC. This embodiment has permanent aligned layers. The layers may, for example, alternate between a layer having one or more light absorbing species only and a layer having one or more light emitting species only. Some embodiments use more than one light absorbing species each with complementary absorption spectra, to harvest a greater portion of the solar spectrum. A suitable scheme for the chemical self assembly of the absorbers and emitters onto the substrate is employed. One embodiment employs zirconium phosphonate linkages between the surface of a substrate, such as a sheet of PMMA or glass, and suitably modified emitting or absorbing centers, and between the layers of absorbing and emitting centers. Absorbing and emitting centers are modified by attaching two phenyl phosphonic acidate groups, one on each end of the absorbing or emitting centers, along a symmetry axis. For emitters, the axis chosen is the one that is substantially coaxial to the transition dipole from which optical emission takes place. For absorbers, which possess degenerate transition dipoles with D₄ₕ or higher symmetry, the axis chosen is coaxial to one of the degenerate transition dipoles involved in absorbing and transmitting energy. A single monolayer of aligned absorbers or emitters is formed when a phosphorylated substrate, having being immersed overnight in 25 mM ZrOCl₂ (aq.) to form a foundation on which absorbers and emitters can assemble, is immersed in a 0.1 mM solution of the suitably modified emitter or absorber for 4 h. Multiple monolayers of aligned species are formed by successive immersion of the substrate in 25 mM ZrOCl₂ for 15 min to form a capping layer over the previous monolayer of absorbers or emitters, and then the 0.1 mM solution of absorbing or emitting centers. The capping layer forms a hew base on which further layers may be assembled.

FIG. 7 show an example product 200 having emitting 204 and absorbing 206 centers arranged in layers on a substrate 202, fabricated using the self-assembly process described above. The light absorbing and light emitting centers are, in this example, physically connected by chemical linkages formed during the self-assembly process. In some examples, there are many repetitions of the layers and a continuous chain of centers is formed.

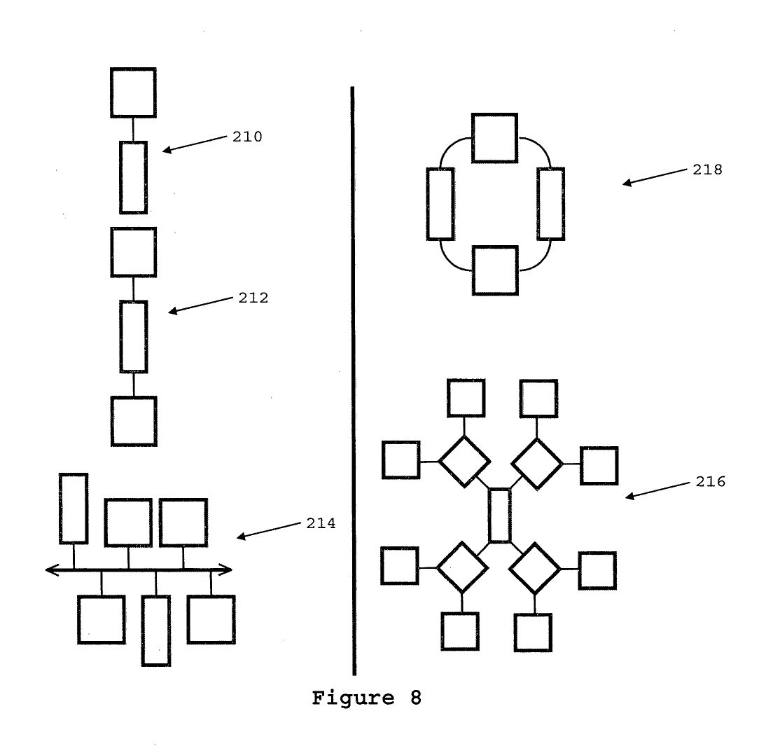

In an alternative example, one or more emitting and one or more absorbing centers may be linked together to form a supra-molecule, examples of which are shown in FIG. 8. The supra-molecule may then, for example, be attached to a substrate or alternatively dispersed within a waveguide. Examples of such supra-molecules include dimmers 210, trimers 212, or larger analogues, dendrimers 216, complexes with one or more species of ligand, polymers 214, cage molecule 218, or any other conjoined system. The linkages between centers may be configured to promote energy transfer between the linked absorbing and emitting centers.

In another example, light emitting and light absorbing centers are located within the same formal molecule, for example a molecule which contains two or more orthogonal transition dipoles with nondegenerate energies.

The LSC formed using the described self-assembly process may have at least one surface of the waveguide coated with layers of absorbing and emitting centers, rather than (or perhaps additional to) the centers being located in the light guide. The surface may be a reflecting surface, such as the reflector.

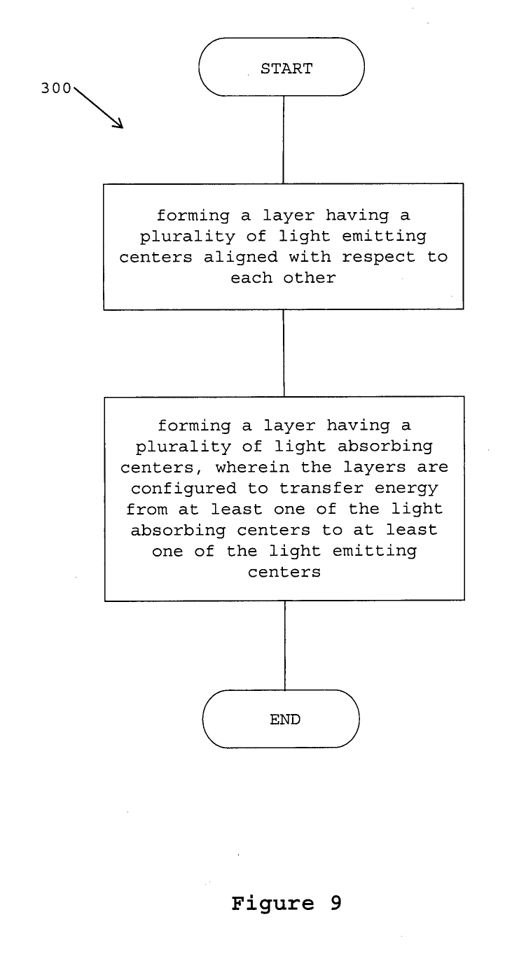

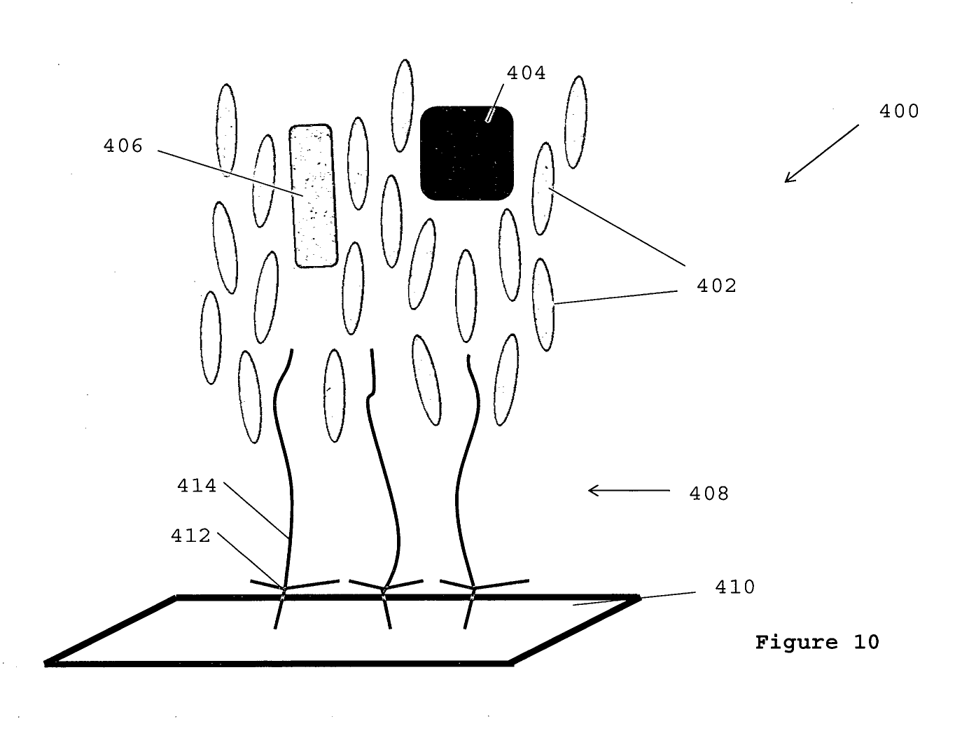

FIG. 9 shows a flow diagram of an embodiment of a method of fabricating a light guide, generally indicated by the numeral 300.

This process is flexible and allows control over the concentration, relative spacing and ratios of different species which influence the energy transfer process. For example, we may wish to deposit one layer of light emitting centers for every three layers of light absorbing centers. The resultant LSC may be dry, and would not require the application of a voltage or the use of transparent conducting oxide layers.

Now that embodiments have been described, it will be appreciated that some embodiments may have some of the following advantages:
Aligning the light emitting centers to maximize the capture of emitted light by the light guide reduces losses in the LSC, making it more efficient.
The use of light absorbing centers distinct from the light emitting centers enhances the absorption of sunlight, making the LSC more efficient.
Using light absorbing centers with transition dipoles having D₄ₕ, higher, cubic or spherical symmetry maximizes both the absorbance of incidence solar radiation, and the rate of energy transfer to the light emitting centers.

Some variations on the specific embodiments include:
Any suitable optical material may be used, for example another polymer instead of PMMA, a glass such as BK-7, or a crystal such as Yttrium Aluminum Garnet;
The light guide 12 may be cylindrical, or any other suitable geometry;
The top 14 and bottom 16 surfaces may have an optical coating or another optical structure to enhance the reflection of rays such as 18 and/or transmission of sunlight into the wave guide;
In the case that total internal reflection is used, the slab may be surrounded by any suitable gas, liquid or solid material which has a lower refraction index than the material that the waveguide is made from;
Any suitable reflection process may be used, not just total internal reflection, for example interference processes in dielectric stack coatings, or reflection processes in Bragg, micro- or nano-structures.
The light absorbing centers may comprise quantum dots, quantum wires, or some other quantum structure with suitable properties, such as the property of having a degenerate optical frequency transition dipole coaxial and parallel to the long axis of a linear particle, where light emission occurs from that dipole;
The light emitting centers may comprise quantum wires, ellipsoids or some other quantum structure with suitable properties;
The energy transfer process may comprise one or more of near field communication, intersystem crossing (ISC), triplet energy transfer (TET), Dexter transfer, IC, and reverse intersystem crossing (rISC), instead of or in addition to FRET.

It will be appreciated that numerous variations and/or modifications may be made to the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-29. (canceled)

30. A luminescent solar concentrator (LSC) comprising:
a light guide defined at least in part by a reflector;
the light guide having a plurality of light absorbing centers that absorb sunlight incident on the light guide;
the light guide also having a plurality of light emitting centers;
each of the plurality of light emitting centers being capable of emitting light after at least some of the energy of the absorbed sunlight is transferred to it from one or more of the light absorbing centers; and
each of the plurality of light emitting centers being orientated relative to the reflector to enhance the proportion of light emitted that is guided within the light guide.

31. A LSC defined by claim 30 wherein the reflector is located adjacent an interface, and the reflector operates by total internal reflection.

32. A LSC defined by claim 30 wherein at least some of the plurality of light absorbing and emitting centers are located in the light guide.

33. A LSC defined by claim 30 wherein at least some of the plurality of light absorbing and emitting centers are located adjacent a surface of the light guide.

34. A LSC defined by claim 30 wherein each of the absorbing centers has at least one of: D₄ₕ symmetry; a symmetry higher than D₄ₕ; and spherical symmetry.

35. A LSC defined by claim 30 wherein each of the plurality of light emitting centers has an axis substantially orthogonal to the reflector.

36. A LSC defined by claim 35 wherein the axis is at least one of: a symmetry axis; and an axis defined by a transition dipole moment of the light emitting centers.

37. A LSC defined by claim 35 wherein the light emitting center is elongated along the axis.

38. A LSC defined by claim 35 wherein the centers are arranged such that the light emitted by each of the centers is greatest in a direction substantially orthogonal to the axis.

39. A LSC defined by claim 35 wherein the light emitted by each of the centers is least in a direction parallel to the axis.

40. A LSC defined by claim 30 wherein the energy transfer is via at least one of Förster resonance energy transfer (FRET), ISC, TET, Dexter energy transfer, near field communication, IC and rISC.

41. A LSC defined by claim 30 wherein each of the light emitting centers comprises a molecule.

42. A LSC defined by claim 30 wherein each of the light absorbing centers comprises a molecule.

43. A LSC defined by claim 30 comprising liquid crystal molecules in which the centers are hosted.

44. A LSC defined by claim 43 wherein the liquid crystal is orientated by the influence of an alignment-inducing species.

45. A LSC defined by claim 44 wherein the alignment-inducing species comprises a surfactant molecule.

46. A LSC defined by claim 44 wherein the alignment-inducing species is dimethyloctadecyl[3-(trimethoxysilyl) propyl] ammonium chloride or hexadecyltrimethylammonium bromide.

47. A LSC defined by claim 44 comprising two pieces between which the liquid crystal molecules are located, and the alignment-inducing species is bound to the pieces.

48. A light guide having light absorption and emission properties, wherein the angular dependence of the light emission enhances the proportion of the emitted light that is guided within the light guide.

49. A light guide defined by claim 48 wherein the angular dependence of the light absorption is different than the angular dependence of the light emission.

50. A light guide defined by claim 48 wherein the angular dependence of the light absorption enhances the proportion of a light incident on the light guide that is absorbed.

51. A luminescent solar concentrator comprising a light guide defined by claim 47.

52. A material having light absorption and emission properties, the angular dependence of the light absorption being different than the angular dependence of the light emission.

53. A method of fabricating a light guide, the method comprising the steps of:
forming a layer having a plurality of light emitting centers aligned with respect to each other; and
forming a layer having a plurality of light absorbing centers;
wherein the layers are configured to transfer energy from at least one of the light absorbing centers to at least one of the light emitting centers.

54. A method defined by claim 53 wherein the step of forming one of the layers uses a self assembly process.

55. A method defined by claim 53 wherein one of the layers is on top of the other.

56. A method defined by claim 53 further comprising the initial steps of:
providing a surface;
and coating the surface with a coating
to which either the light emitting centers or light absorbing centers can bond.

57. A method defined by claim 56 comprising the step of modifying either the light emitting centers or the light absorbing centers to have end groups that can bond to the coating.

58. A method defined by claim 57 comprising the step of bonding the modified light emitting centers to the coated surface.
